(19) United States
(12) Patent Application Publication
(10) Pub. No.: US 2014/0165207 A1
(43) Pub. Date: Jun. 12, 2014

(54) METHOD FOR DETECTING ANOMALY ACTION WITHIN A COMPUTER NETWORK

(71) Applicants: Giora Engel, Mevaseret Zion (IL); Michael Mumcouglu, Jerusalem (IL)

(72) Inventors: Giora Engel, Mevaseret Zion (IL); Michael Mumcouglu, Jerusalem (IL)

(73) Assignee: LIGHT CYBER LTD., Ramat Gan (IL)

(21) Appl. No.: 14/234,165

(22) PCT Filed: Jul. 25, 2012
(86) PCT No.: PCT/IL2012/050272

§ 371 Date: Jan. 22, 2014

Related U.S. Application Data
(60) Provisional application No. 61/511,568, filed on Jul. 26, 2011.
(60) Provisional application No. 61/543,356, filed on Oct. 5, 2011.

(51) Int. Cl. H04L 29/06

(52) U.S. Cl. CPC H04L 63/1425
USPC 726/25

(57) ABSTRACT

A method and system for detecting anomalous action within a computer network is provided herein. The method starts with collecting raw data from at least one probe sensor that is associated with at least one router, switch or at least one server which are part of the computer network. Next, the raw data is being parsed and analyzed and meta-data is created from the raw data. Computer network actions are being identified based on existing knowledge about network protocols. The meta-data is associated with entities by analyzing the identified network actions and correlating between different computer network actions. Finally, creating at least one statistical model of the respective computer network said model including network actions' behavior pattern and online or batch detection of anomalous network actions associated with entities based on the statistical models.

### CROSS-REFERENCE TO RELATED PATENT APPLICATIONS

This application claims the benefit of U.S. Provisional patent application No. 61/511,568 filed on Jul. 26, 2011, and of U.S. Provisional patent application No. 61/543,356 filed on Oct. 5, 2011, which are incorporated herein by reference in its entirety.

### FIELD OF THE INVENTION

The present invention relates generally to the field of cyber security and more particularly to detection of anomaly action within a computer network.

### BACKGROUND OF THE INVENTION

A large number of significant Advanced Persistence threats (APTs) which shocked the computer security community were published lately. These publications had brought the realization that the threats had fundamentally changed. One example of a shocking threat (attack) was published by Google™ and named Aurora. During the Aurora attack emails were sent to perform phishing attacks that brought the attacked to open a malicious website that took advantage of a weakness in the browser and installed a Trojan horse. The Trojan horse enables the attacker to take full control on the attacked computer and also to spread itself to other computers in the network of the organization.

In another example that was disclosed by RSA, a security firm that provides security services to leading companies in the world, RSA was attacked in order to collect classified information and to use this information to breach RSA security product that is being used by a customer of RSA and classified information has been stolen.

Due to the are enormous type of Malware which have new variants which change every day, traditional security countermeasures fails to prevent the malware malicious acidity

### BRIEF DESCRIPTION OF THE DRAWINGS

The present invention will be more readily understood from the detailed description of embodiments thereof made in conjunction with the accompanying drawings of which:

FIG. 1 illustrates a computer network having multiple sensors connected to components, according to some embodiments of the present invention;

FIG. 2A and FIG. 2B illustrate a system for detecting anomaly action in a computer network, according to some embodiments of the present invention;

FIG. 3 illustrates activity of a condenser module, according to some embodiments of the present invention;

FIG. 4 illustrates an identification module activity by utilizing meta-data from the condenser, according to one embodiment of the present invention;

FIG. 5 illustrates a statistical modeling module activity, according to some embodiments of the present invention;

FIG. 6 illustrates an anomaly detection module activity, according to some embodiments of the present invention; and

FIG. 7 illustrates decision engine module activity, according to some embodiments of the present invention.

### SUMMARY OF THE INVENTION

The present invention discloses a method for detecting anomalous action within a computer network. The method comprises the steps of:
collecting raw data from at least one probe sensor that is associated with at least one router, switch or at least one server which are part of the computer network, said raw data includes at least one of: traffic data, logs and flow data;
parsing and analyzing the raw data;
creating meta-data from said raw data;
identifying computer network actions based on existing knowledge about network protocols;
associating the meta-data with entities by analyzing the identified network actions and correlating between different computer network actions, wherein entities include at least one of: Internet Protocol, IP address, users, services, protocols, servers and workstations; and
creating at least one statistical model of the respective computer network, said model including network actions' behavior pattern; and
online or batch detection of anomalous network actions associated with entities based on the statistical models.

According to some embodiments of the present invention the step of running queries regarding actions of entities in the computer network and outside of the computer network by using a query sensor.

According to some embodiments of the present invention the method further comprising the step of eliminating duplications.

According to some embodiments of the present invention the method further comprising the step of correlating between different actions in the computer network for associating computer network actions.

According to some embodiments of the present invention the method further comprising the step of querying components in the computer network to receive relevant information for identifying relevant identities associated with computer network actions.

According to some embodiments of the present invention the method further comprising the step of associating collected data to entities that are outside the computer network.

According to some embodiments of the present invention the method further comprising the step of applying machine learning algorithms for creating statistical behavioral models.

According to some embodiments of the present invention the method further comprising the step of maintaining statistical models of behavior over multiple time periods for each entity.

According to some embodiments of the present invention the method further comprising the step for creating connectivity graph between entities for identifying functionality of entities and/or detecting abnormal connectivity.

According to some embodiments of the present invention the method further comprises the step of clustering entities based on their actions by identifying common characteristics.

According to some embodiments of the present invention the method further comprises the step of generating behavioral models for each entity and a model for each group of entities with common characteristics.

According to some embodiments of the present invention the detecting anomalies comprise the step of comparing each action in the received data to models of entities and models of clusters of entities for analyzing likelihood of action validity.

According to some embodiments of the present invention the detecting anomalies comprise the step of comparing a group of actions pattern to the received data to models of entities and models of clusters of entities, wherein actions pattern includes at least one of: number of action per time or frequency usage.

According to some embodiments of the present invention the method further comprises the steps of creating incidents by aggregating and clustering related anomalies based on specified parameters and ranking said incidents.

According to some embodiments of the present invention the method further comprising the step of generating notifications or alerts based on identified anomalies according to predefined rules.

According to some embodiments of the present invention the method further comprising the step of generating alerts based on identified anomalies according to identified attack patterns.

According to some embodiments of the present invention the method further comprising the step of representing analyzed meta-data in a structured format.

According to some embodiments of the present invention the method further comprising continuously building a statistical model of the computer network, said model includes network actions behavioral patterns for different time periods.

According to some embodiments of the present invention, wherein ranking of incidents is accomplished by collecting and analyzing assisting information from entities.

According to some embodiments of the present invention the method further comprising the step of receiving feedback regarding generated alerts.

According to some embodiments of the present invention, wherein the detection of anomalous network actions is continuous over at least one time period.

According to some embodiments of the present invention, wherein the creating of at least one statistical model is preformed over multiple time periods.

The present invention discloses a system for detecting anomalous action within a computer network. The system comprised of:
probe sensors associated with at least one router or at least one server in the computer network for collecting raw data, wherein raw data includes at least one of: traffic data, logs and flow data;
a network security processing unit associated with at least one sensor, said unit comprising:
   a condenser module for parsing and analyzing the raw data and identifying computer network actions based on existing knowledge of network protocols;
   a memory medium for representing analyzed meta-data in a structured format;
   an association module for associating the meta-data with entities by analyzing the identified actions and correlating between different actions in the computer network, wherein entities include at least one of: users, services, protocols, servers and workstations;
   a statistical modeling module for building a statistical model of the computer network, said model including:
      network actions behavior pattern for different time periods;
   an anomaly detection module for online or batch detection of anomalies of actions associated with entities based on the statistical model.

According to some embodiments of the present invention the system further comprises decision engine module for determining alerts based on detected anomalies and predefined rules.

According to some embodiments of the present invention the system further comprises the decision engine module for determining alerts based on identified anomalies according to identified attack patterns.

According to some embodiments of the present invention, wherein one of the probe sensors is a query sensor that is running queries regarding action of entities in the computer network and outside of the computer network.

According to some embodiments of the present invention, wherein the condenser module is further eliminating duplications and processing data.

According to some embodiments of the present invention the system further comprises, wherein the association module is further correlating between different actions in the computer network for associating between network actions and network entities.

According to some embodiments of the present invention, wherein one of the probe sensors is a query sensor that is querying components in the computer network to receive relevant information for identifying relevant identities associated with computer network actions.

According to some embodiments of the present invention, wherein the association module is further associating collected data to entities that are outside of the computer network.

According to some embodiments of the present invention, wherein the statistical module is further of maintaining statistics of protocols and entities pattern behavior over time periods for each entity.

According to some embodiments of the present invention, wherein the identification module is further clustering entities based on their computer network actions by identifying common characteristics.

According to some embodiments of the present invention, wherein the identification module is further generating a behavior pattern model for each entity and a model for each cluster of entities.

According to some embodiments of the present invention, wherein the anomaly detection module is further comparing each computer network action in the received data to models of entities and models of clusters of entities for analyzing likelihood of action validity.

According to some embodiments of the present invention, wherein the anomaly detection module is further comparing a group of computer network actions pattern, in the received data to models of entities and models of clusters of entities.

According to some embodiments of the present invention, wherein the decision module further creates incidents by aggregating and clustering related anomalies based on specified parameters and ranking said incidents.

According to some embodiments of the present invention, wherein the decision engine module further ranks incidents by collecting and analyzes assisting information from entities.

According to some embodiments of the present invention, wherein the decision engine module further receives feedback regarding generated alerts.

According to some embodiments of the present invention wherein the detection of anomalous network actions is continuous over at least one time period.

According to some embodiments of the present invention, wherein the creating of at least one statistical model is preformed over multiple time periods.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

In cyber-security there are generic attacks which don't target a specific person or organization and targeted attacks. Even a generic malware can evade detection due to many reasons—one of them is the large number of new variants. Even one specific threat can have hundreds of new variants that are not detected by the original rule or signature. In addition, targeted attacks or Advanced Persistent Threats (APT) have changing and complex patterns of behavior that are similar to normal usage of the network and usually evade detection of security systems. APT commonly aims to maintain a long-term access to a target in order to achieve defined objectives.

The present invention, in some embodiments thereof, provides a system for detection of anomaly action and deviation from the normal behavior pattern of the computer network. The anomaly action may be caused by a generic malware of by a more targeted cyber attack such as APT and may be detected by statistical modeling of the computer network that enables differentiating the anomaly action from the normal behavior.

In the following application the term “entity” relates to users, services, protocols, servers, workstations, mobile devices and network devices.

In the following application the term “flow data” relates to network protocols used to collect Internet Protocol (IP) traffic information such as: netflow, a network protocol of Cisco™ Systems, IP Flow Information (IPFIX), sFlow and the like.

In the following application the term “raw data” relates to packets, traffic data, flow data, logs, queries and network protocols.

In the following application the term “Supervisory Control And Data Acquisition (SCADA)” relates to computer systems that monitor and control industrial, infrastructure, or facility-based processes.

The term “computer network” refers to any computer network such as: Local Area Network (LAN), Wide Area Network (WAN), SCADA and a computer network that uses communication Protocol technology such as IP protocol to share information, operational systems, or computing services within an organization or outside of it.

According to some embodiments of the present invention, there are provided a method and a system for detecting anomaly action within a computer network. The method and system are based on advanced algorithms for collecting data and associating entities in the computer network in order to statistically model an action of a single entity and action of a group of entities.

According to some embodiments of the invention, an anomaly action in the computer network may be identified utilizing the method and system described above and upon identification may generate alerts that specify the nature of threat.

For example, Google™ Inc. as a multinational corporation operates several data centers which are located worldwide may have some of the corporation's assets connected to the internet and as such may be exposed to APT attacks. The corporation's assets may be personal data of clientele, financial data and other classified data on development of products and services. A method and a system that may provide an early detection warning may be advantageous and prevent most of the damage caused by cyber attacks.

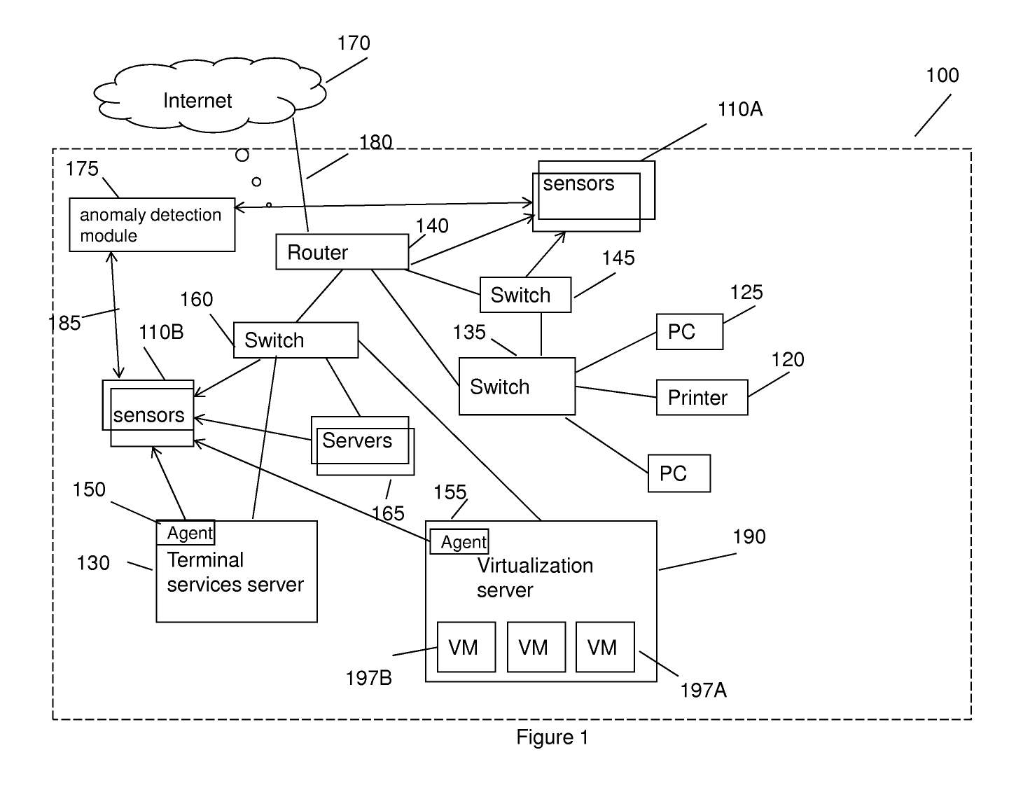

FIG. 1 illustrates a computer network 100 having multiple sensors 110A and 110B (referenced as 110) connected to components of the computer network, according to some embodiments of the present invention.

In a non-limiting example, a computer network of Google™ Inc. may be connected to the internet 170. Sensors 110 may be connected to network devices in the computer network 100 such as: (i) a switch 145 (ii) a router 140; (iii) a virtualization server 190, terminal services sever 130 or other servers 190.

According to some embodiments of the present invention, the sensors 110 may collect data from several places in the computer network 100 and after analysis of the collected data the sensors 110 may send the data to an anomaly detection module 175.

According to some embodiments of the present invention, agents 150 and 155 which are software components may be installed on computers where collection of network data is not possible. For example, communication between multiple Virtual Machines (VMs) 197 that are running on virtualization server 190 is not passing through the physical network and therefore may be monitored and collected by an agent 155. In an another example, when multiple workstations connect to a terminal server 130, an agent 150 may be used to differentiate network communications of different users and associate each user activity to the right user that performed it

According to some embodiments of the present invention, as illustrated in FIG. 1, an anomaly detection module 175 may be connected to sensors 110 via the computer network 100 within the organization network or via the Internet.

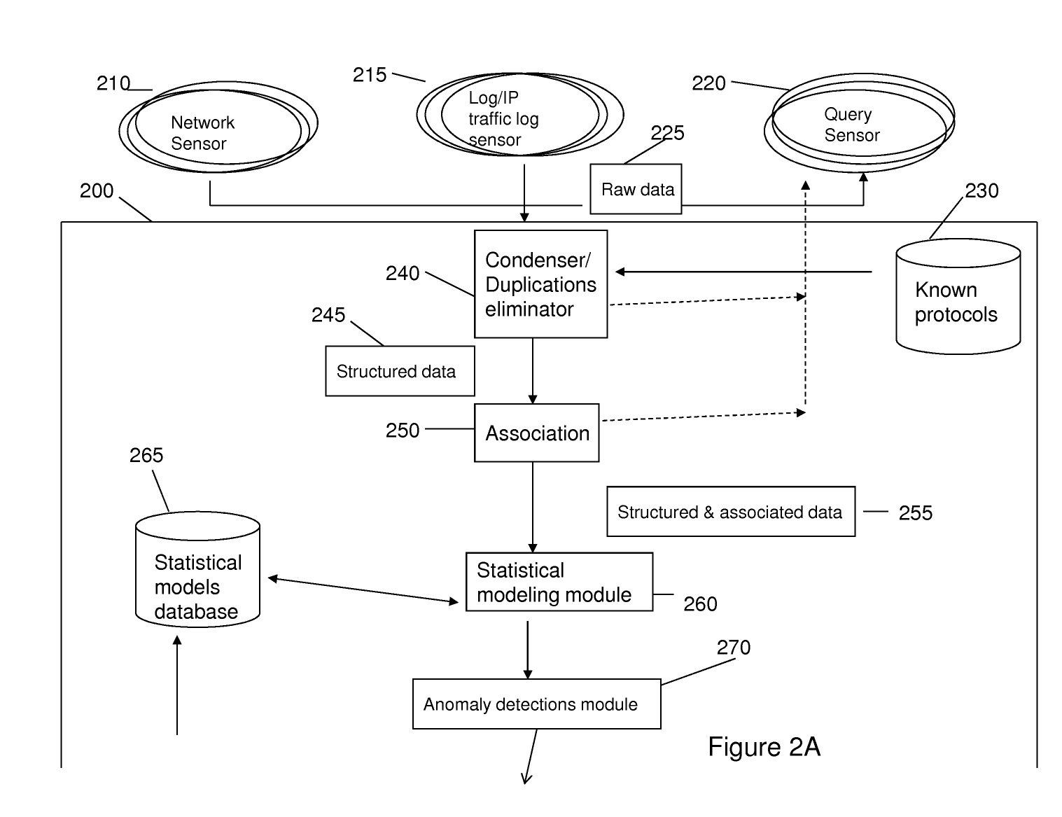

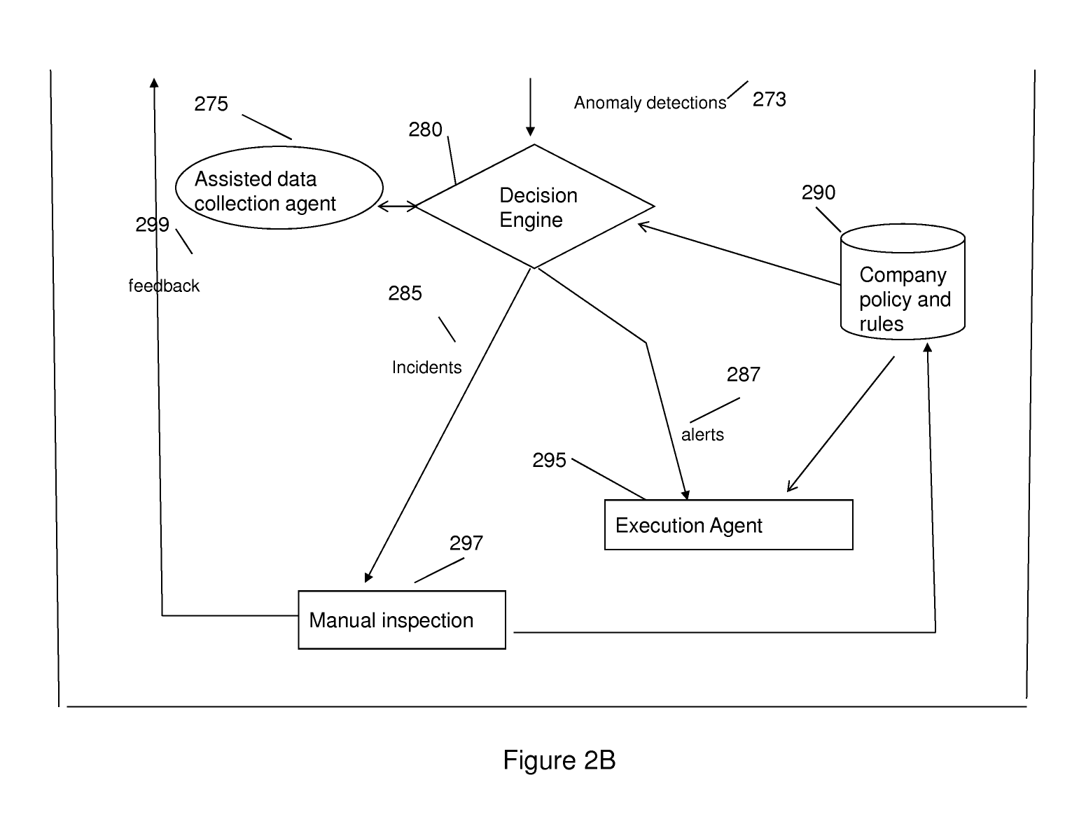

According to other embodiments of the present invention, as illustrated in FIG. 2, a system for detecting anomaly action in a computer network is comprised of an anomaly detection module 200 that is associated to one or more sensors. The sensors may be: multiple network sensors 210, IP traffic log sensors 215 and query sensors 220.

According to other embodiments of the present invention, passive sensors such as network sensors 210 may collect and record network packets from the computer network 100 in FIG. 1. The network sensors 210 may extract relevant data for detecting attacks from the collected data.

According to other embodiments of the present invention, passive sensors such as IP traffic log sensors 215 may collect: (i) flow data from the network devices in the computer network; and (ii) logs from various servers in the computer network. The server may be for example, file server, electronic mail server, a server that responds to security authentication requests, a SIEM (security information and event management) system and the like.

According to other embodiments of the present invention, active sensors such as query sensors 220 which may act upon a trigger may run queries on services that are provided by servers and terminals in the computer network and outside the computer network. The purpose of the queries is to gather specific information such as the currently logged-on user name, running processes, the owner of an IP address or a domain and so forth. Query sensors may poll for information periodically and not act upon a trigger. According to other embodiments of the present invention, the anomaly detection module 200 may receive raw data from one or more sensors. For parsing and analyzing the raw data into meta-data based on existing knowledge about each protocol, a condenser and duplication eliminator module 240 in the anomaly detection module 200 may be activated.

The condenser and duplication eliminator module 240 may receive raw data from all sensors in the computer network and may perform de-duplication and processing of the raw data to store only relevant meta-data in a structured format (245). The duplication may occur for example, as result of receiving raw data from different sources in different formats such as: sniffed network packets, IP traffic logs or other log data that represent the same event. Another example of duplication is receiving the same raw data from different locations in the network—for example from a sensor connected to a backbone switch and a sensor connected to another switch.

According to other embodiments of the present invention, the condenser and duplication eliminator module 240 may be comprised of the following components: (i) network protocols analyzer; (ii) logs analyzer; (iii) data flow analyzer; and (iv) duplication eliminator component.

The network analyzer may parse received packets to extract relevant data in a structured format for each action such as: IP addresses, names of files, dates and the like. The log analyzer may extract relevant data from logs. The data flow analyzer may receive various types of formats and extract most relevant information when given only partial data from each format of data flow. Since data is received from multiple sources it is essential to eliminate these duplications to prevent arriving at a wrong conclusion regarding the number of times that an action was performed in the computer network. Eliminating duplications may be performed in two stages: first stage is when packets are received and second stage is in structured format that was extracted by the network analyzer. The second stage is important since data is received from multiple sensors which are located in various locations in the computer network.

According to other embodiments of the present invention, the condenser and duplication eliminator module 240 may transmit structured data (245) regarding actions to an association module 250. The association module 250 may associate the received structured data regarding actions in the computer network to an entity. An entity may be an (Internet Protocol) IP address, a user, a service, a server or a workstation.

Association may also be performed for entities that are outside the organization's network. Each entity may be a part of a larger group. For example, an IP address can belong to a subnet, an AS (autonomous system), a domain name, a specific service or a company. Association can be hierarchical.

According to other embodiments of the present invention, the association may be performed by correlating between network actions while the actions are taking place in the computer network or by active queries against various network devices (or services) in the computer network. For example if a user login is detected on a specific workstation it is assumed that all the traffic that originates from it is associated with the user, until he logs out or until another user logs in.

According to other embodiments of the present invention, a statistical modeling module 260 may receive structured data (255) regarding actions with associated entities for continuously building a statistical model of the computer network.

According to other embodiments of the present invention, a model for a group of users may be built over time in addition to modeling per single user. Building a model for a group of users i.e. clustering may divide users into groups by similar properties. During the process of clustering the statistical modeling module 260 may create one or more groups of users that have common properties of action in the computer network regardless of their unit classification. For example, managers may be clustered into the same group instead of clustering a manager with employees of the same business unit.

According to other embodiments of the present invention, there are several types of models: (i) statistical models based on parameters or based on groups of parameters or based on parameter aggregates; (ii) statistical models of association and or connectivity between entities (i.e. users and services) or between components; and (iii) statistical models of relationships between entities. (iv) models for sequences of actions.

The model may include actions behavior pattern for different time periods in different levels of detail (for example the actions from the last day can be stored as is, from the last month it can be stored in 1 day aggregates, for the last year in 1 month aggregates, etc). The statistical modeling module 260 is a learning component that works offline i.e. not necessarily when actions are performed in the computer network. Data of the statistical models may be stored in a statistical models database 265.

According to other embodiments of the present invention, the anomaly detection module 270 receives information regarding actions in the computer network and identifies anomalous behavior by comparing actual network actions with the statistical models. The anomalies may be sent to a decision engine 280. The purpose of the decision engine 280 is to aggregate relevant anomalies together and create incidents. The incidents may be reported as notifications 285 regarding anomaly action or an attack activity.

According to some embodiments of the present invention, a training process is performed automatically over multiple time periods, preforming statistical analysis of network actions at each period. The training process continues until a statistically significant stabilization of the statistical model is reached. The statistical strength of the model may affect the priority or respective “weight” given to the detected abnormalities.

According to other embodiments of the present invention, at least part of the training process may be performed manually. The notifications 285 may be sent to a manual inspection 297. The manual inspection 297 may determine if an action is false positive or not and the feedback (299) of the manual inspection may be sent to the statistical models database 265.

According to other embodiments of the present invention, the anomalies are identified by one of the following: (i) comparing a single action in the computer network to the statistical model; and (ii) comparing a group of actions in the computer network to the statistical model.

According to other embodiments of the present invention, anomalies can be detected by finding specific entities that differ in their behavior from the majority of other entities in the computer network which have similar functionality, or finding actions that differ from the majority of actions in their characteristics. This method works on a batch of data and detects the anomalies rather than compare a specific action to a model. One example is detecting workstations that connect to many destinations on a certain protocol, while most of the other workstations connect to only a few. This method uses models of behavior that represent a certain timespan (such as a day, a week, a month, etc) and analyze a bulk of data finding outliers (anomalous actions of entities). Sometimes a single action may not indicate on an anomaly, however the aggregated behavior of the entity may be significant to trigger an anomaly.

According to other embodiments of the present invention, the decision engine 280, may analyze several anomaly actions and generate incidents/alerts based on identified anomalies according to predefined rules such as company policy rules (290) or based on identified anomalies according to identified attack patterns.

The decision engine can use assisted data collection agent 275 for receiving feedback from users before generating an alert.

The incidents/alerts 287 are reported to an execution agent 295 which may apply prevention activities according to company policy and rules 290 for blocking or hindering the suspicious activity. For example suspending a specific entity from using the computer network 100, disconnecting the offending computer from the network, locking user account or blocking specific network traffic.

According to other embodiments of the present invention, a linguistic component may generate a description that will clarify context of alerts.

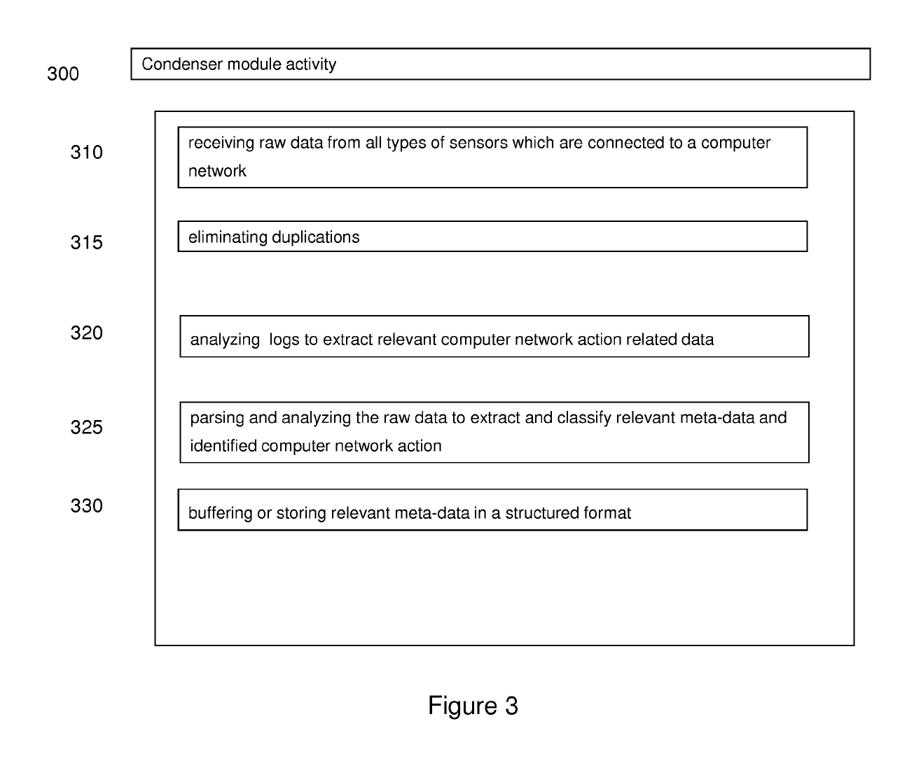

FIG. 3 illustrates activity of a condenser module, according to some embodiments of the present invention.

According to some embodiments of the present invention, the condenser module may receive information from at least one sensor in the computer network and may perform de-duplication and processing to store only the relevant meta-data in a structured format. The data that was received from at least one sensor may be in raw format such as sniffed network packets or can be IP traffic logs or other log data. The condenser module may analyze specific network protocols and extract relevant meta-data.

The activity of the condenser module may begin with receiving raw data from all types of sensors which are connected to a computer network (stage 310). After data is received from at least one sensor the condenser may eliminate duplications (stage 315).

According to some other embodiments of the present invention, the condenser module may analyze logs to extract relevant computer network action related data (stage 320).

According to some other embodiments of the present invention, the condenser module may parse and analyze the raw data that was received from at least one sensor to extract and classify relevant meta-data and identified computer network action (stage 325). The analysis may parse multiple packets which may support one or more network actions. After relevant meta-data is extracted and classified it may be buffered or stored in a structured format (stage 330).

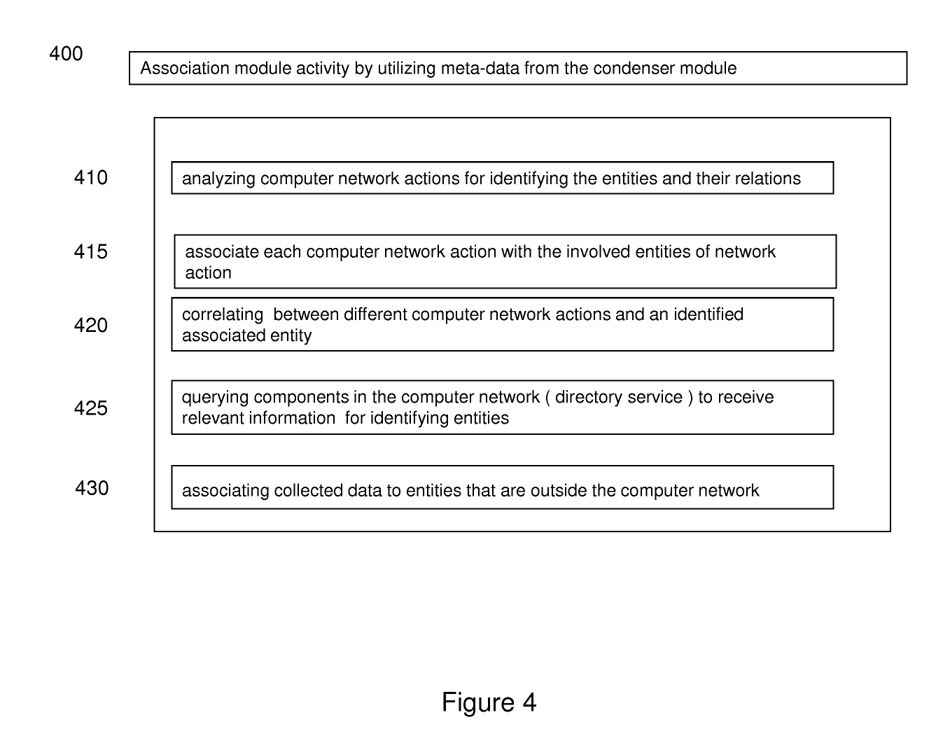

FIG. 4 illustrates an association module activity by utilizing meta-data from the condenser, according to one embodiment of the present invention.

According to some other embodiments of the present invention, the association module may identify the entities and their relations (stage 410) based on analyzing computer network actions received from the sensors, such as user logins, address resolutions, configuration and zero-configuration actions, and queries to relevant servers such as directory servers. Some entities are related to other, for example a set of IP addresses in the same subnet, a set of users in the same business unit, etc

According to some other embodiments of the present invention, the association module may associate each action with the relevant entities involved (stage 415). (i.e. IP addresses, users, services servers or workstations)

For example, accessing a file in the network can be associated to the originating workstation that generated the traffic and to specific user that is logged in on the workstation at the same time. Another example is data that is transferred from the web-server to the database server which is associated with the web application service running on the web server.

According to some other embodiments of the present invention, the association may be hierarchical. For example, a user may be a part of an organizational group, which may be part of a larger group. Another example, is an IP that is a part of a subnet which is a part of an AS which belongs to a company.

The association between network actions and entities can be achieved by the following steps described in steps 420 and 425.

According to some other embodiments of the present invention, association module activity may correlate between different computer network actions occurring in the same session period to identified associated entities (stage 420). For example if a user login action is detected on a specific workstation, it is assumed that all the traffic that originates from the workstation is associated with the logged in user, until the user logs out or until another user logs in. There is time correlation between the login and the other actions that are originated by the workstation.

According to some other embodiments of the present invention, association module activity may actively query components in the computer network (e.g. directory service) to receive relevant information for identifying relevant identities of entities (stage 425). For example query the directory service for the IP address of a server within the computer network to receive information about the server such as name and purpose or the server, or query a computer to get the current logged-in user.

According to some other embodiments of the present invention, the association module may associate collected data to entities that are outside the computer network (stage 430). Each entity may be a part of a larger group.

For example, an IP address may belong to: a subnet, an Autonomous System (AS), a domain name, a specific service (such as Gmail or Facebook) or a company.

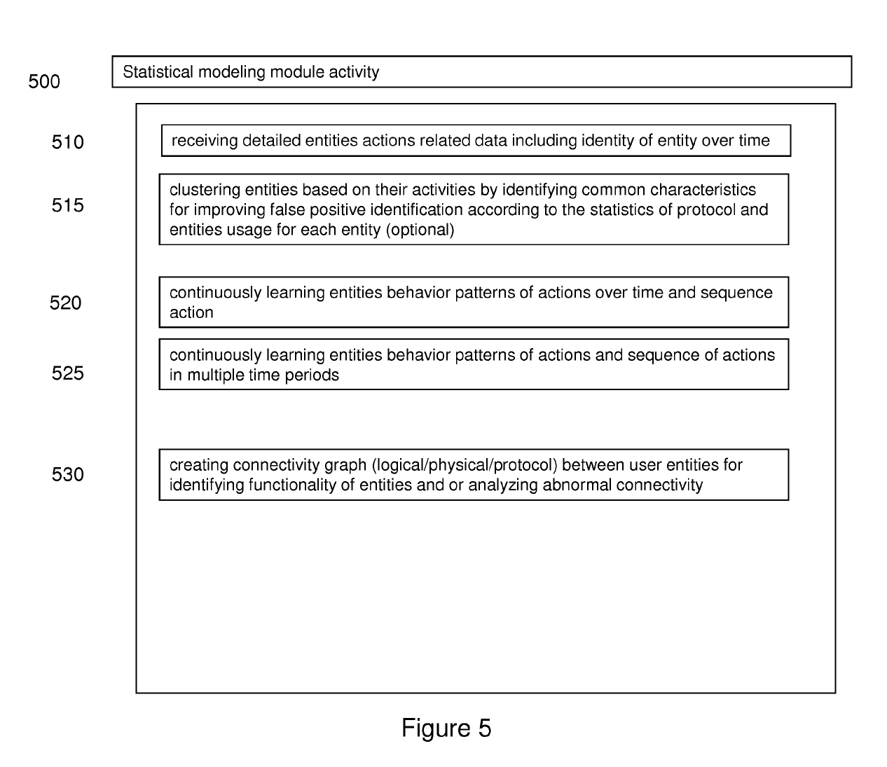

FIG. 5 illustrates a statistical modeling activity, according to some embodiments of the present invention.

According to some other embodiments of the present invention, the system may use machine learning algorithms to build a model for each user or service. The statistical model describes the normal behavior in generalized/aggregated terms. The following steps describe the process of generating the statistical models:

Entities usually utilize their credentials in a very minimalistic way. For example, it is a common practice to grant access to more than the specific files that a user uses, but in practice each user uses a very small portion of the resources the user has access to. Another example: theoretically each computer can send packets to all other computer in the network but in practice the number of destinations for each computer is small. The generalization process learns from the actions of the entity and defines the actual resources used by the entity and the pattern of usage (including but not limited to frequency of usage, bandwidth, applicative description of actions performed, etc.).

Each captured packet, IP traffic record i.e. flow data (such as NetFlow) or log record is part of an action. The action may be a TCP session or a logical action (such as a file transfer within an open TCP session, which can be followed by additional actions). Additional packets or records may enrich the information known about the current action and may create a new or sub-action.

The action Meta data is then enriched with the associated entities and their roles. The roles represent the accumulated data the system learned about the entities and their interaction with other entities in the network. Role information is given by an automatic analysis of the network entities according to the characteristics of their associated historical actions within the network. For example, the endpoints in a network can be servers or workstations. The automatic analysis can detect the roles of each endpoint and this information is used by the modeling process as workstations and servers may have different characteristics. Another example of roles is administrative users vs. regular users. The two groups have different behavior in the network.

According to some embodiments of the present invention, statistical modeling module may begin with receiving detailed entities actions related data including identity of entity over time from the association module activity (stage 510). For example, the statistical modeling module 260 in FIG. 2A may receive data over time such as: a user “X” accessed a file on the files' server in a specified time. The data may include parameters such as: size of the file, the file's location in the files' server, name of the file and the like. After processing the received information, the statistical modeling module 260 in FIG. 2A may build a model for the user and a model for a group of users which represent the behavior of the user or group.

According to some embodiments of the present invention, an optional step is clustering entities based on their activities by identifying common characteristics, such clustering improves false positive identification according to the statistics of protocol and entities usage for each entity (stage 515).

For example, managers of units in an organization may be clustered instead of clustering a manager with the manager's subordinate employees working in the same unit. Thus, preventing false-positive identification of anomaly actions by comparing a manager's action in the computer network to other manager's action in the computer network instead of comparing the manager's action in the computer network to the manager's subordinates' employees.

According to some other embodiments of the present invention, the statistical modeling module may be continuously learning entities behavior patterns of actions and sequence of actions over time (stage 520). Many actions are often part of a larger sequence of actions. For example connecting to a VPN includes a few login layers, accessing a file is usually preceded by querying its attributes, etc. Looking at the sequence of actions is sometimes more meaningful than looking at each specific action.

Statistical models may be built over time based on parameters of actions in the computer network or based on groups of parameters of actions in the computer network. The system may continuously receive data and may continuously update the statistical model quantitatively as well as qualitatively. The statistical models may be build by automatically finding statistically strong parameters in the computer network over time, such as schedule, protocol and other connectivity related parameters. The parameters may be found by utilizing machine learning algorithms such as decision trees. For that purpose, the statistical modeling module creation process may correlate sequences of actions (stage 520 or 525) and apply a machine learning algorithm. The leaning algorithm enables identifying statically significant events by, for example, using structured information database such as decisions trees or creating N-dimensional information structures. A parameter can be a quantity or an aggregate of a quantity. For example: volume of traffic, number of different IP addresses accessed, etc. A group of parameters is a tuple of a few parameters that are analyzed together.

Additionally, the statistical modeling module may maintain statistics of protocol and entities usage/pattern behavior over multiple time periods for each entity (stage 525). For example over the last hour, over the last day, last week, last month, or last year. Some changes or anomalies are relevant when something happens in one minute (for example a large number of connections originating from one computer), and other anomalies are relevant in longer timespans (an aggregate number of failed connections to the same server over 1 week). The level of detail can vary between the different time periods to maintain a manageable dataset. For example on a 1-year timespan the average number of connections will be saved for each month and not each specific connection.

In order to build a statistical model for each entity in the computer network over time, protocols and interaction with other entities may be continuously examined to store statistics for each entity. For example, time of protocol usage, duration of usage, amount of usage of each resource and other statistics related to properties of the usage. Specifically connections between entities in the computer network that are found and didn't exist previously add more data to the models.

Since components in the computer network may have several functions, for example, a component may function as a server in certain protocols and as a client in other protocols, an association graph may assist in identifying the function of the components in the computer network. The statistical modeling module learns different types of behavior of servers and of clients in the computer network. For example, a backup server connects to other servers in the computer network while a storage server receives information from other servers in the computer network.

Different types of entities in the computer network may have a relationship with one another, for that purpose, statistical models of relationships between entities may be built over time. For example, in a certain domain may be a number of Internet Protocol (IP) addresses. A specific user may login on a specific terminal station therefore a relationship between the specific user and the Media Access Control (MAC) address of the specific terminal station may be identified. Other examples are relationship between IP address and username or between IP address and a physical port in a switch and the like. A change in one of the described relationships may indicate an anomaly action.

According to some other embodiments of the present invention, analyzing connectivity (logical/physical/protocol) data between user entities may be used for identifying functionality or role of entities and/or for detecting abnormal connectivity (stage 530). Statistical models of association between entities may be built over time by modeling association graphs between different users in the computer network. The association graph may be comprised of: (i) a logical level between users; (ii) a physical level between various components or between servers in the computer network; and (iii) various protocols can be modeled separately, for example, a situation where a backup server communicates with other servers for providing backup services does not imply that all the servers are connected to each other.

The combination of all previous actions, results in a behavior pattern model for each entity and a model for each cluster of entities.

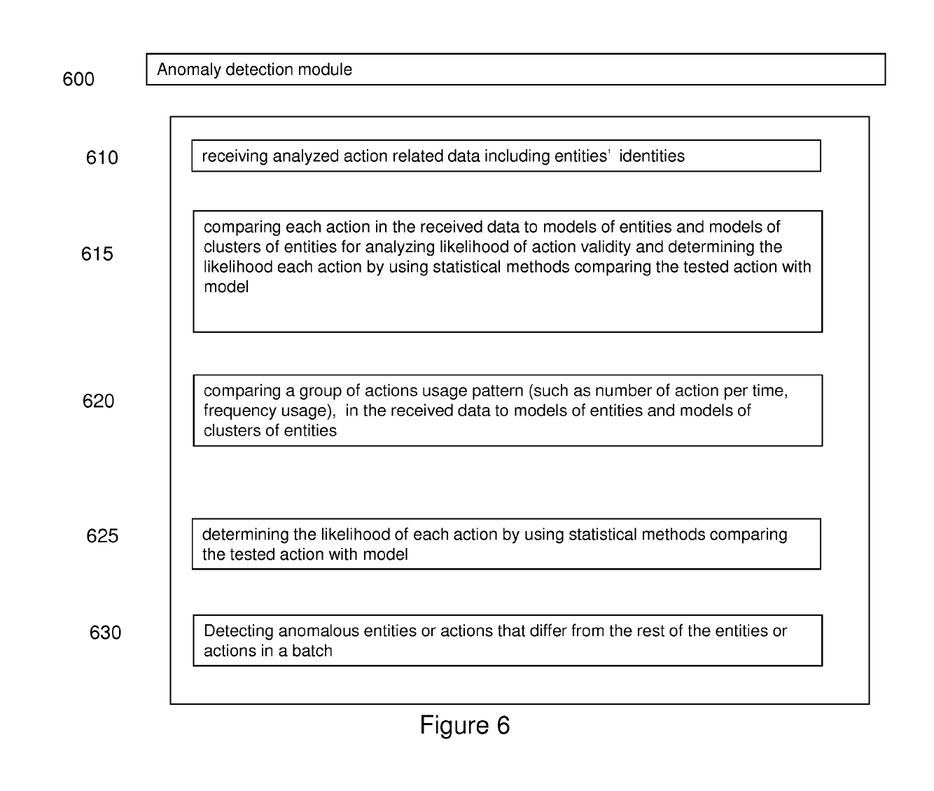

FIG. 6 illustrates an anomaly detection module activity, according to some embodiments of the present invention.

According to some embodiments of the present invention, the anomaly detection module may begin with receiving analyzed action related data including entities' identities (stage 610). Comparing each action in the received data to models of entities and models of clusters of entities for determining the likelihood each action by using statistical methods comparing the tested action with model (stage 615).

For comparing a single action in the computer network to the statistical model, probability may be calculated for each single action in the computer network. For example, identifying outgoing communication that occurred at a time that is not typical to a specific user. Another example may be when a server starts behaving as a workstation i.e. the function of the server is changed. When a new relationship is created in the connectivity graph, a probability of the relationship is calculated by a distance function. In case of detecting a high distance measure of a new created relationship between components, the probability of the new relationship is considered to be low, and therefore it is regarded as suspicious. For example, identifying an action in the computer network where a user logged in to a computer that does not belong to his organizational unit.

Many actions are often part of a larger sequence of actions. For example connecting to a VPN includes a few login layers, accessing a file is usually preceded by querying its attributes, etc. Actions that appear without their contextual sequence may be anomalous and distance measure calculation is applied to quantify the difference from normal behavior.

According to some embodiments of the present invention, the anomaly detection module may compare a group of actions usage pattern (such as number of action per time, frequency usage), in the received data to models of entities and models of clusters of entities (stage 620). For each group of actions quantities parameters may be examined when comparing a group of actions in the computer network to the statistical model. Quantities parameters may be: time elapsed between actions, amount of actions, rate of actions that took place and the like. For example, quantitative identification of a user's access to a thousand files may be identified as an anomalous action when compared to the statistical model in which the user has accessed a maximum of only a dozen files. In this example the anomaly is in the amount of access to files and not each access to a file by itself. Another type of anomaly that can be checked and identified is inconsistency. Anomaly may be detected when identifying changes of relations between entities and/or their types, such as a 1:1 or one-to-many or many-many relation between entities/identities.

For example: A Domain Name System (DNS) name typically corresponds to one or more IP addresses. A physical port typically corresponds to one or more Ethernet addresses. When changes occur in the relations between identities—likelihood is calculated. If there is a low likelihood for the respective action to occur an anomaly may be reported.

According to some other embodiments of the present invention, the anomaly detection module may score the detected anomalies according to their statistical significant.

For each enriched action (action and entities and roles) the anomaly detection module evaluates its characteristics based on the accumulated data extracted so far (packets, protocol decoding, agents, logs, records, etc.). The system may represent the action object as a feature vector in one or more N-dimensional vector spaces. It may use clustering algorithms, non-parametric statistical methods and/or a pre-defined map of clusters representing green zones, to find the closest known network action in each vector space. Finally, the anomaly detection module calculates a distance metric (represented in terms of probability) for the current action.

The distance measure is used by the anomaly detection module to differentiate normal and anomalous actions. A low distance measure (high probability) indicates a normal behavior. A high distance measure (low probability) indicates an anomalous action (and the degree of the anomaly). Another factor that may affect the determination of anomalous action is the identity and type of entity or its role in the current context such as the role of the entity within the network For example an action can be considered as routine for an admins user but anomalous for a business user.

Distance measures work on any comparable feature (dimension) of an action including but not limited to address, size, time, bandwidth, service type, resource path, access type, etc. When an action is identified as anomalous the system identifies the dimensions or features that contribute most to the distance measure. Furthermore multiple anomalies with similar characteristics may be aggregated and grouped together.

According to some other embodiments of the present invention, the anomaly detection module may represent each action in an N dimensional vector and determine the likelihood of each action by using statistical methods including comparing the tested action with the model (stage 625).

According to some other embodiments of the present invention, anomalies can be detected by finding specific entities that differ in their behavior from the majority of other entities in the computer network, or finding actions that differ from the majority of actions in their characteristics and their associated entities (stage 630). This method works on a batch of data and detects the anomalies between entities or actions rather than compare a specific action to a model. One example is detecting workstations that connect to many destinations on a certain protocol, while most of the other workstations connect to only a few. This method uses models of behavior that represent a certain timespan (such as a day, a week, a month, etc) and analyze a bulk of data finding outliers (anomalous actions of entities). This may be performed by clustering the data and find outliers or small clusters that do not cluster well with the other groups.

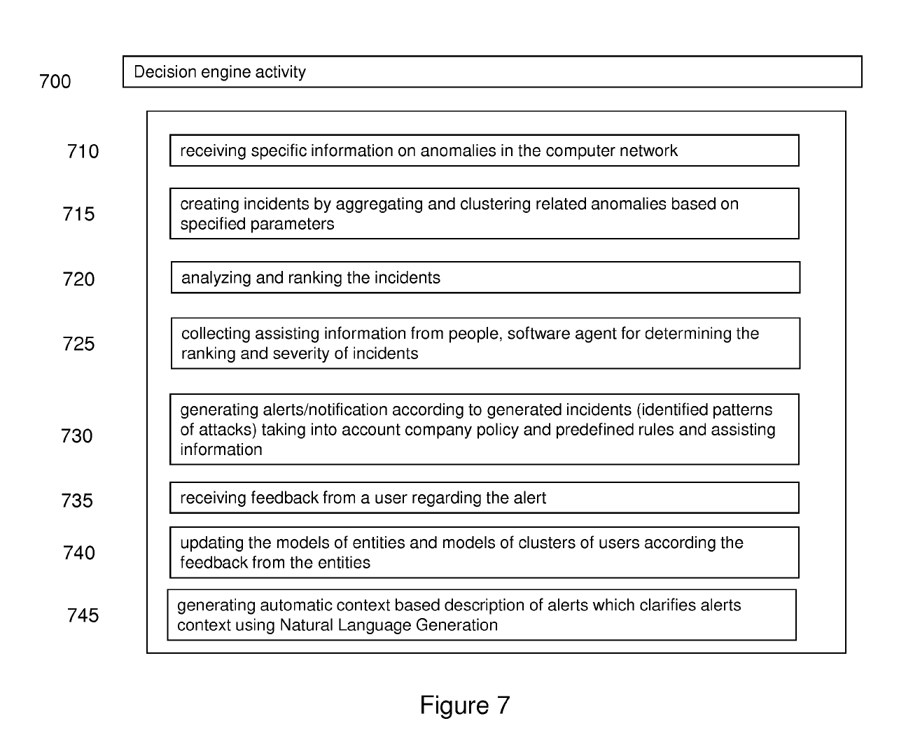

FIG. 7 illustrates activity of the decision engine module, according to some embodiments of the present invention.

According to some embodiments of the present invention, the decision engine module receives specific information on anomalies in the computer network (stage 710). Next, the decision engine module may be creating incidents by aggregating and clustering related anomalies based on specified parameters (stage 715) and then analyzing and ranking the incidents (stage 720).

According to some embodiments of the present invention, the decision engine module collects assisting information from people, software agents and/or based on company policy and predefined rules, for determining the ranking and severity of incidents (stage 725).

According to some embodiments of the present invention, assisted False Positive Filtering and Informative Reporting are used in order to reduce the number of false positives generated by the anomaly detection engine. Such reporting may enhance the information included in notifications. For this purpose, a process of collecting augmentative data is performed. This data can be collected in various forms for example by host-based software agents. User feedback may aid to distinct between intended and unintended actions. Interaction with the end-user can be achieved by using different communication methods such as: e-mail, mobile phone notification, SMS/Text, P2P software, instant messenger, etc. The user response (intended/unintended/do not know/etc.) or lack thereof can then be logged, processed and analyzed.

The assisting user can be the user with which the traffic is associated with or an appointed individual. The assisting information can collected from one or more users. Information from software agents can include running processes, currently logged-on-user, open ports, process associated with a given port, and so on. The data can be used in further analysis and to enhance notifications with information that can help the operator quickly make a decision and act upon a given notification. The collected information can be used before a notification is issued, or to provide additional information for a previously issued notification.

According to some embodiments of the present invention, the decision engine module generates alerts/notification about the incidents (identified patterns of attacks) taking into account company policy and predefined rules and assisting information (stage 730).

Upon the alerts, the decision engine module may be receiving feedback from a user regarding the generated alerts (stage 735).

Next, the decision engine module may be updating the models of users and models of clusters of users according the feedback from the user (stage 740). If the feedback suggests that the network activity is benign the decision engine will update the models so that this activity will be considered benign. If the activity is still suspicious or detected as malicious the decision engine may keep the incident open and update it upon receiving new related anomalies or data from the anomaly detection. The decision engine may send alerts/notification upon the update of the incident data.

When an incident is marked as malicious the affected assets (users, workstations, servers, etc . . . ) may be marked as compromised. The priority of compromised assets is elevated and the threshold of the filter is lowered (to enable more subtle anomalies related to the compromised assets to show). Further expansion of the threat is contained, and can be supervised by a human operator.

According to some embodiments of the present invention, the system may use accumulative operator's reactions to past events. These accumulated reactions may trigger the creation of a new user created “green zones”. Thresholds within the system are updated continuously based on the operator's feedback.

According to some embodiments of the present invention, the decision engine module may be generating automatic context based description of alerts which clarifies alerts context using Natural Language Generation (NLG) (stage 745).

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for detecting anomalous action within a computer network:
collecting raw data from at least one probe sensor that is associated with at least one router, switch or at least one server which are part of the computer network, said raw data includes at least one of: traffic data, logs and flow data;
parsing and analyzing the raw data;
creating meta-data from said raw data;
identifying computer network actions based on existing knowledge about network protocols;
associating the meta-data with entities by analyzing the identified network actions and correlating between different computer network actions, wherein entities include at least one of: Internet Protocol, IP address, users, services, protocols, servers and workstations; and creating at least one statistical model of the respective computer network, said model including network actions' behavior pattern; and
online or batch detection of anomalous network actions associated with entities based on the statistical models.

2. The method according to claim 1 further comprising the step of running queries regarding actions of entities in the computer network and outside of the computer network by using a query sensor.

3. The method according to claim 1 further comprising the step of eliminating duplications.

4. The method according to claim 1 further comprising the step of correlating between different actions in the computer network for associating computer network actions.

5. The method according to claim 1 further comprising the step of querying components in the computer network to receive relevant information for identifying relevant identities associated with computer network actions.

6. The method according to claim 1 further comprising the step of associating collected data to entities that are outside the computer network.

7. The method according to claim 1, further comprising the step of applying machine learning algorithms for creating statistical behavioral models.

8. The method according to claim 1 further comprising the step of maintaining statistical models of behavior over multiple time periods for each entity.

9. The method according to claim 1 further comprising the step for creating connectivity graph between entities for identifying functionality of entities and/or detecting abnormal connectivity.

10. The method of claim 1 further comprising the step of clustering entities based on their actions by identifying common characteristics.

11. The method of claim 1 further comprising the step of generating behavioral models for each entity and a model for each group of entities with common characteristics.

12. The method of claim 1, wherein detecting anomalies comprise the step of comparing each action in the received data to models of entities and models of clusters of entities for analyzing likelihood of action validity.

13. The method of claim 1, wherein detecting anomalies comprise the step of comparing a group of actions pattern to the received data to models of entities and models of clusters of entities, wherein actions pattern includes at least one of: number of action per time or frequency usage.

14. The method of claim 1 further comprising the steps of creating incidents by aggregating and clustering related anomalies based on specified parameters and ranking said incidents.

15. The method of claim 1 further comprising the step of generating notifications or alerts based on identified anomalies according to predefined rules.

16. The method of claim 1 further comprising the step of generating alerts based on identified anomalies according to identified attack patterns.

17. The method of claim 1 further comprising the step of representing analyzed meta-data in a structured format.

18. The method of claim 1 further comprising the step of continuously building a statistical model of the computer network, said model includes network actions behavioral patterns for different time periods.

19-21. (canceled)

22. The method of claim 1 wherein the creating of at least one statistical model is preformed over multiple time periods.

23. A system for detecting anomalous action within a computer network, said system comprised of:
probe sensors associated with at least one router or at least one server in the computer network for collecting raw data, wherein raw data includes at least one of: traffic data, logs and flow data; and
a network security processing unit associated with at least one sensor, said unit comprising:
a condenser module for parsing and analyzing the raw data and identifying computer network actions based on existing knowledge of network protocols;
a memory medium for representing analyzed meta-data in a structured format;
an association module for associating the meta-data with entities by analyzing the identified actions and correlating between different actions in the computer network, wherein entities include at least one of: users, services, protocols, servers and workstations;
a statistical modeling module for building a statistical model of the computer network, said model including:
network actions behavior pattern for different time periods; and
an anomaly detection module for online or batch detection of anomalies of actions associated with entities based on the statistical model.

24-40. (canceled)
